(19) United States
(12) Patent Application Publication
(10) Pub. No.: US 2015/0190806 A1
(43) Pub. Date: Jul. 9, 2015

(54) FLUID CONTROL IN MICROFLUIDIC DEVICE

(71) Applicant: Corning Incorporated, Corning, NY (US)

(72) Inventor: Po Ki Yuen, Painted Post, NY (US)

(21) Appl. No.: 14/418,215

(22) PCT Filed: Jul. 18, 2013
(86) PCT No.: PCT/US13/50980

§ 371 Date: Jan. 29, 2015

Related U.S. Application Data
(60) Provisional application No. 61/677,710, filed on Jul. 31, 2012.

(51) Int. Cl. B01L 3/00

(52) U.S. Cl. CPC B01L 3/502746

(57) ABSTRACT

A method of operating a microfluidic device (15), wherein the microfluidic device comprises a microfluidic channel (20), a fluid conveyance extension (30), and an absorbent microfluidic flow modulator (35). The microfluidic channel extends from a channel outlet chamber (25) of the microfluidic device and the fluid conveyance extension is fluidly coupled to the channel outlet chamber. The absorbent microfluidic flow modulator is configured to absorb a fluid from the fluid conveyance extension when fluidly coupled to the fluid conveyance extension. The method comprises admitting the fluid into the microfluidic channel and the channel outlet chamber, saturating the fluid conveyance extension with the fluid, and generating a fluid flow in the microfluidic channel by fluidly coupling the absorbent microfluidic flow modulator to the fluid conveyance extension to absorb the fluid from the fluid conveyance extension.

### BACKGROUND

This application claims the benefit of priority under 35 U.S.C. §119 of U.S. Provisional Application Ser. No. 61/677710 filed on Jul. 31, 2012 the content of which is relied upon and incorporated herein by reference in its entirety.

### FIELD

The present disclosure relates generally to the field of microfluidic devices and more particularly to a method of generating a fluid flow in the microfluidic device.

### TECHNICAL FIELD

Microfluidic devices, which may be referred to as microstructured reactors or modules, microchannel reactors or modules, microcircuit reactors or modules, or microreactors, are devices in which a fluid can be confined and subjected to reactive or non-reactive processing. In some applications, the processing may involve the analysis of chemical reactions. In other applications, the processing may involve chemical, physical, and/or biological processes such as a cell culture executed as part of a manufacturing or production process. In some applications, one or more working fluids confined in the microfluidic device may exchange heat with one or more associated heat exchange fluids. In any case, the characteristic smallest dimensions of the confined spaces for the working fluids are generally on the order of 0.1 nm to 5 mm, desirably 100 nm to 500 gm.

Microchannels are the most typical form of such confinement, and the microfluidic device may operate in a number of roles, e.g. as a continuous-flow reactor or module or as a cell culture chamber. The internal dimensions of the microchannels provide considerable improvement in mass and heat transfer rates. Microreactors and flow modules that employ microchannels offer many advantages over conventional-scale reactors, including vast improvements in energy efficiency, reaction speed, reaction yield, safety, reliability, scalability, etc. The microchannels may be arranged, for example, within a layer that is a part of a stacked structure such as the structure shown in US PG Pub. 2012/0052558, where a stacked microfluidic device comprises a layer in which reactant passages comprising microchannels are positioned.

### SUMMARY

A method of operating a microfluidic device, wherein the microfluidic device comprises a microfluidic channel, a fluid conveyance extension, and an absorbent microfluidic flow modulator. The microfluidic channel extends from a channel outlet chamber of the micro fluidic device and the fluid conveyance extension is fluidly coupled to the channel outlet chamber. The absorbent microfluidic flow modulator is configured to absorb a fluid from the fluid conveyance extension when fluidly coupled to the fluid conveyance extension. The method comprises admitting the fluid into the microfluidic channel and the channel outlet chamber, saturating the fluid conveyance extension with the fluid, and generating a fluid flow in the microfluidic channel by fluidly coupling the absorbent microfluidic flow modulator to the fluid conveyance extension to absorb the fluid from the fluid conveyance extension.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 is a perspective view of a microfluidic device;

FIG. 2 is a schematic view of the microfluidic device and an embodiment of the absorbent microfluidic flow modulator; and

FIG. 3 is a schematic view of the microfluidic device and another embodiment of the absorbent microfluidic flow modulator.

### DETAILED DESCRIPTION

Before turning to the figures, which illustrate several embodiments in detail, it should be understood that the application is not limited to the details or methodology set forth in the description or illustrated in the figures. It should also be understood that the terminology is for the purpose of description only and should not be regarded as limiting.

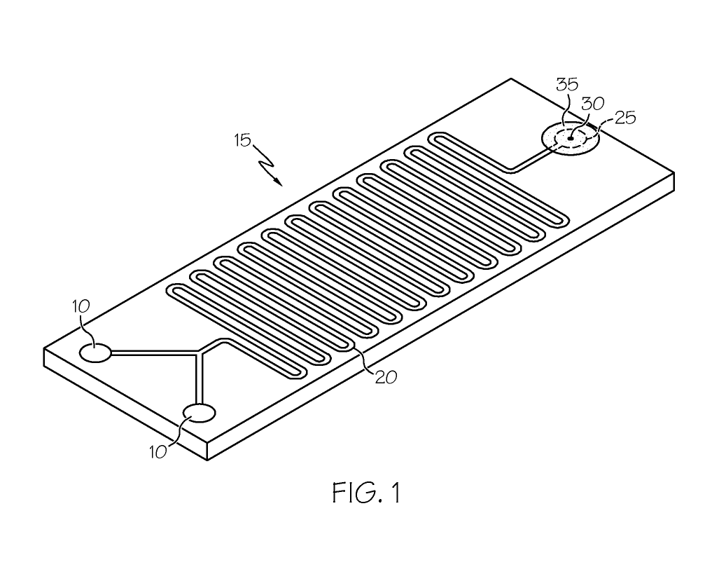

Referring to FIG. 1, an embodiment of an absorbent microfluidic flow modulator 35 on a microfluidic device 15 is shown. A microfluidic channel 20 fluidly connects a channel inlet chamber 10 and a channel outlet chamber 25. A fluid conveyance extension 30 is fluidly coupled to the channel outlet chamber 25 and to the absorbent microfluidic flow modulator 35 through contact. A fluid or multiple fluids are admitted into the microfluidic device 15 filling the microfluidic device 15 to a desired level and completely saturating the fluid conveyance extension 30. Saturated as used throughout this application is used to describe the inability to absorb any more fluid.

The absorbent microfluidic flow modulator 35 generates a fluid flow in the microfluidic channel 20 by fluidly coupling the absorbent microfluidic flow modulator 35 to the fluid conveyance extension 30 and absorbing the fluid from the fluid conveyance extension 30 through, for example, capillary action. It is important to note that the fluid conveyance extension 30 preferably remains saturated as the absorbent microfluidic flow modulator 35 generates the fluid flow. If the fluid conveyance extension 30 does not remain saturated, then it will typically become more difficult to control the microfluidic channel flow rate using the absorbent microfluidic flow modulator 35. It may be advantageous in some embodiments for the fluid conveyance extension 30 to protrude from the microfluidic device 15 up to about 5 mm to help ensure that the fluid conveyance extension 30 remains saturated.

The fluid conveyance extension 30 may comprise a thread, a filter paper, a membrane filter, a nitrocellulose paper, fiberglass, a cellulose acetate membrane, a cellulose nitrate membrane, cotton-based materials, or any material suitable to convey fluid through capillary action. The micro fluidic device 15 may be fabricated through injection molding, hot embossing, photolithography, soft lithography, stereolithography, etching, molding, laser ablation micromachining, or combination thereof. The microfluidic channel 20 may have a variety of cross-sectional shapes. For example, contemplated shapes include but are not limited to a cross-sectional geometry of up to about 1 mm wide by about 500 μm tall or a diameter that is between about 100 nm to about 1 mm. The absorbent microfluidic flow modulator 35 may be chosen from a membrane filter or any cellulose-based material to include filter paper, copy paper, a paper towel, tissue paper or nitrocellulose paper.

It is contemplated that the absorbent microfluidic flow modulator 35, which forms part of the microfluidic device 15, may be directly or indirectly connected to the remainder of the microfluidic device 15. For example, it may reside on a surface of the microfluidic device 15 or may be an independently portable part of the microfluidic device 15. In one embodiment, the absorbent microfluidic flow modulator 35′ comprises a non-absorbent, semi-rigid, portable fluid coupling port 40 that allows portability of the absorbent microfluidic flow modulator 35′. Embodiments utilizing the non-absorbent, semi-rigid, portable fluid coupling port 40 are described in further detail herein with reference to FIG. 3.

The microfluidic channel flow rate of the fluid flow in the microfluidic channel 20 is chosen to meet the processing needs associated with the particular mode of operation of the microfluidic device 15. Because the fluid in the microfluidic channel 20 is fluidly coupled with the fluid conveyance extension 30, and the fluid conveyance extension 30 is fluidly coupled with the absorbent microfluidic flow modulator 35, an absorption rate of the absorbent microfluidic flow modulator 35, which is the rate at which the absorbent microfluidic flow modulator 35 absorbs fluid, matches the chosen microfluidic channel flow rate. Therefore, the microfluidic channel flow rate is set by the absorption rate of the absorbent microfluidic flow modulator 35.

The absorption rate of the absorbent microfluidic flow modulator 35 may be controlled in a variety of ways. For example, the absorbent microfluidic flow modulator 35 may control the microfluidic channel flow rate by an evaporative or non-evaporative control mechanism, or a combination thereof. Those practicing the concepts of the present disclosure will appreciate that the ability to control the microfluidic channel flow rate enables versatility in varying the mixing ratios of multiple fluids or varying the speed of the fluid in a heat exchange process, for example.

It is contemplated that the following design parameters can play a role in evaporative or non-evaporative control mechanisms: the volume and/or density of the absorbent microfluidic flow modulator 35; the amount of contact area between the absorbent microfluidic flow modulator 35 and the fluid conveyance extension 30; the composition of the absorbent microfluidic flow modulator 35; environmental conditions; etc. Considering the role that volume and/or density plays in effecting flow rate, typically, the volume of the absorbent microfluidic flow modulator 35 will indicate how much fluid the absorbent microfluidic flow modulator 35 can absorb before becoming saturated. The volume along with the flow rate is indicative of the length of time the absorbent microfluidic flow modulator 35 may be in contact with the fluid conveyance extension 30 before the fluid flow in the microfluidic channel 20 ceases.

Considering the effect that a contact area plays in controlling the absorption rate, it is noted that an increased amount of contact area between the absorbent microfluidic flow modulator 35 and the fluid conveyance extension 30 enables a larger amount of fluid to be absorbed by the absorbent micro fluidic flow modulator 35, thereby increasing the microfluidic channel flow rate. The composition of the absorbent microfluidic flow modulator 35 relates to the absorption properties of the absorbent microfluidic flow modulator 35. Cellulose-based materials exhibit desirable absorption properties. Gel-based absorption materials as well as manufactured devices for absorption may be used.

The evaporative control mechanism associated with a particular absorbent microfluidic flow modulator 35 may furthermore be affected by environmental conditions such as temperature and/or humidity of the air surrounding the absorbent microfluidic flow modulator 35 or the temperature of the absorbent micro fluidic flow modulator 35 itself. Airflow over the absorbent microfluidic flow modulator 35 as well as an exposed evaporative surface area of the absorbent microfluidic flow modulator 35 are also design parameters that affect the evaporation rate as well. The exposed evaporative surface area is at least one order of magnitude larger than the contact area and is a part of the absorbent microfluidic flow modulator 35 that is susceptible to environmental conditions.

In contrast, non-evaporative control mechanisms do not rely on evaporation to control the absorption rate. As such, the absorbent micro fluidic flow modulator 35 and corresponding absorption rates will be less likely to be influenced by environmental conditions and will be more likely to be influenced by the volume and/or density of the absorbent micro fluidic flow modulator 35; the amount of contact area between the absorbent microfluidic flow modulator 35 and the fluid conveyance extension 30; the composition of the absorbent microfluidic flow modulator 35. As stated above, the composition of the absorbent microfluidic flow modulator 35 affects the absorption rate. This allows the absorption rate to remain unchanged when the absorbent micro fluidic flow modulator 35 is at least partially enclosed in a non-porous membrane. For example, the non-porous membrane may be the non-absorbent, semi-rigid, portable fluid coupling port 40 of FIG. 3.

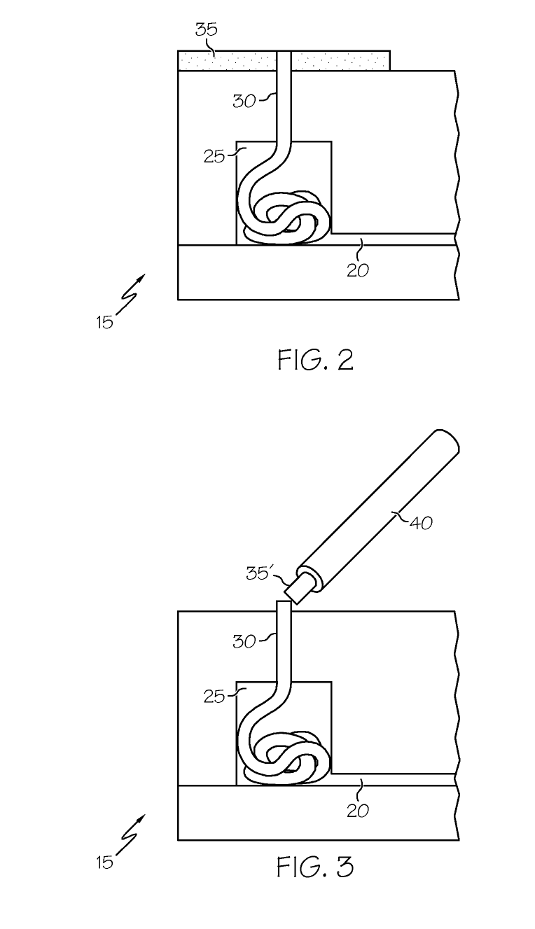

FIG. 2 depicts a schematic view of the microfluidic device 15. The fluid conveyance extension 30 resides in the channel outlet chamber 25 and fluidly couples the microfluidic channel 20 with the absorbent microfluidic flow modulator 35. In this embodiment, the absorbent microfluidic flow modulator 35 resides on the surface of the microfluidic device 15 and will start to generate fluid flow when the fluid conveyance extension 30 is saturated with the fluid. The fluid flow will cease upon either the condition that the fluid is completely absorbed out of the microfluidic device 15 or the condition that the absorbent microfluidic flow modulator 35 becomes saturated.

FIG. 3 is another embodiment of the absorbent microfluidic flow modulator 35′. By placing the absorbent microfluidic flow modulator 35′ in the non-absorbent, semi-rigid, portable fluid coupling port 40, the absorbent micro fluidic flow modulator 35′ is portable and enables the ability to start and stop the microfluidic channel flow rate quickly. These traits are desirable because multiple absorbent microfluidic flow modulators 35′ may be used on multiple microfluidic channels 20 in a microfluidic device 15 to vary the microfluidic channel flow rate without changing the fluids or the microfluidic device 15. The absorbent microfluidic flow modulator 35′ is inserted into the non-absorbent, semi-rigid, portable fluid coupling port 40 and can be stored in that configuration until needed. This advantage allows multiple non-absorbent, semi-rigid, portable fluid coupling ports 40 with absorbent microfluidic flow modulator 35′ of varying characteristics to be made and stored until needed.

The non-absorbent, semi-rigid, portable fluid coupling port 40 provides a way to handle the absorbent microfluidic flow modulator 35′ without affecting the absorbent microfluidic flow modulator 35′ characteristics or exposure to the fluid once it is absorbed. The absorbent microfluidic flow modulator 35′ is not limited to be inserted and could be wrapped around the non-absorbent, semi-rigid, portable fluid coupling port 40 externally. Furthermore, the absorbent microfluidic flow modulator 35′ could be used to collect the fluid for later processing.

It is also noted that recitations herein of “at least one” component, element, etc., should not be used to create an inference that the alternative use of the articles “a” or “an” should be limited to a single component, element, etc. For example, the microfluidic device 15 could have multiple microfluidic channels 20, channel inlet chambers 10 and/or channel outlet chambers 25. Furthermore, multiple absorbent microfluidic flow modulators 35 of varying characteristic could have contact with one or more fluid conveyance extensions 30 at once.

For the purposes of describing and defining the present disclosure it is noted that the terms “substantially,” “about,” and “approximately” are utilized herein to represent the inherent degree of uncertainty that may be attributed to any quantitative comparison, value, measurement, or other representation. For example, the microfluidic channel 20 diameter is between “about” 100 nm to “about” 1 mm signifies that the diameter of the microfluidic channel 20 encompasses not only variation that result from fabrication but also variations that are necessitated by the type of fluid or desired use of the microfluidic device 15. The terms “substantially,” “about,” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various embodiments described herein. Further, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

While the present disclosure has been particularly shown and described with reference to specific embodiments, it should be understood by those skilled in the art that various changes in form and detail may be made therein without departing from the spirit and scope of the disclosure as defined by the appended claims.

What is claimed is:

1. A method of operating a micro fluidic device, wherein:
the micro fluidic device comprises a micro fluidic channel, a fluid conveyance extension, and an absorbent microfluidic flow modulator;
the microfluidic channel extends from a channel outlet chamber of the microfluidic device;
the fluid conveyance extension is fluidly coupled to the channel outlet chamber;
the absorbent microfluidic flow modulator is configured to absorb a fluid from the fluid conveyance extension when fluidly coupled to the fluid conveyance extension; and
the method comprises
admitting the fluid into the microfluidic channel and the channel outlet chamber,
saturating the fluid conveyance extension with the fluid, and
generating a fluid flow in the microfluidic channel by fluidly coupling the absorbent microfluidic flow modulator to the fluid conveyance extension to absorb the fluid from the fluid conveyance extension.

2. The method of claim 1 wherein the absorbent microfluidic flow modulator comprises a non-absorbent, semi-rigid, portable fluid coupling port.

3. The method of claim 2 wherein the non-absorbent, semi-rigid, portable fluid coupling port is a tube.

4. The method of claim 1 wherein the absorbent microfluidic flow modulator is fluidly coupled to the fluid conveyance extension by contact.

5. The method of claim 1 further comprising:
selecting a microfluidic channel flow rate; and
selecting the absorbent micro fluidic flow modulator such that it is characterized by an absorption rate that matches the selected microfluidic channel flow rate.

6. The method of claim 1 wherein the absorbent microfluidic flow modulator controls a microfluidic channel flow rate by an evaporative control mechanism, a non-evaporative control mechanism, or combination thereof.

7. The method of claim 1 wherein the absorbent microfluidic flow modulator is at least partially enclosed in a non-porous membrane.

8. The method of claim 1 wherein:
the absorbent micro fluidic flow modulator comprises a contact area and an exposed evaporative surface area;
the absorbent microfluidic flow modulator is fluidly coupled with the fluid conveyance extension via the contact area; and
the exposed evaporative surface area is at least one order of magnitude larger than the contact area.

9. The method of claim 1 further comprising fabricating the microfluidic device through injection molding, hot embossing, photolithography, soft lithography, stereolithography, molding, laser ablation micromachining etching or combinations thereof.

10. The method of claim 1 wherein the fluid conveyance extension protrudes from the microfluidic device up to about 5 mm.

11. The method of claim 1 wherein the fluid conveyance extension is configured to draw the fluid by capillary action.

12. The method of claim 1 wherein the fluid conveyance extension is a thread, a filter paper, a membrane filter, a nitrocellulose paper, fiberglass, a cellulose acetate membrane, a cellulose nitrate membrane, or cotton-based materials.

13. The method of claim 1 wherein the absorbent microfluidic flow modulator comprises a cellulose-based material or a membrane filter.

14. The method of claim 1 wherein the microfluidic channel has a diameter between about 100 nm to about 1 mm.

15. The method of claim 1 wherein the microfluidic channel has a cross-sectional geometry of up to about 1 mm wide by about 500 gm tall.

16. The method of claim 1 wherein:
the microfluidic device further comprises a channel inlet chamber; and
the microfluidic channel extends from the channel inlet chamber to the channel outlet chamber.

17. A method of operating a microfluidic device, wherein:
the microfluidic device comprises a microfluidic channel, a channel inlet chamber, a fluid conveyance extension, and an absorbent microfluidic flow modulator;
the microfluidic channel extends from a channel outlet chamber of the microfluidic device;
the microfluidic channel extends from the channel inlet chamber to the channel outlet chamber;
the fluid conveyance extension is fluidly coupled to the channel outlet chamber;
the fluid conveyance extension protrudes from the microfluidic device up to about 5 mm;
the absorbent microfluidic flow modulator is configured to absorb a fluid from the fluid conveyance extension when fluidly coupled to the fluid conveyance extension;
the absorbent micro fluidic flow modulator is fluidly coupled to the fluid conveyance extension by contact;
the absorbent microfluidic flow modulator controls a microfluidic channel flow rate by an evaporative control mechanism, a non-evaporative control mechanism, or combination thereof; and
the method comprises
admitting the fluid into the microfluidic channel and the channel outlet chamber,
saturating the fluid conveyance extension with the fluid,
generating a fluid flow in the microfluidic channel by fluidly coupling the absorbent microfluidic flow modulator to the fluid conveyance extension to absorb the fluid from the fluid conveyance extension,
selecting the microfluidic channel flow rate, and
selecting the absorbent micro fluidic flow modulator such that it is characterized by an absorption rate that matches the selected microfluidic channel flow rate.
